(19) United States
(12) Patent Application Publication
(10) Pub. No.: US 2002/0184507 A1
(43) Pub. Date: Dec. 5, 2002

(54) Centralized single sign-on method and system for a client-server environment

(75) Inventors: David Makower, Irvington, NY (US); Steven Schwell, New York, NY (US); Jay Sachs, Williamstown, MA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ProAct Technologies Corp., Duluth, GA

(21) Appl. No.: 09/871,525

(22) Filed: May 31, 2001

(51) Int. Cl. H04K 1/00

(52) U.S. Cl. 713/182; 713/201

(57) ABSTRACT

The present invention generally relates to the field of secure centralized single sign-on and session maintenance for web servers on the Internet. In a preferred implementation, a single sign-on protocol for use by web servers is independent of the actual authentication mechanism used by any of the individual web servers accessed by the user. Users authenticate themselves with any one of a group of federated servers so that a user does not need to be re-authenticated by other servers in the federation. In a preferred implementation there is also a centralized server that provides for the transparent sign-on, session management, and session termination within each server in the federation of servers, and each federated server communicates with the central sign-on server.

### BACKGROUND OF THE INVENTION

The present invention generally relates to the field of secure centralized single sign-on and session maintenance for web servers on the Internet.

The Internet, also referred to as a global computer network, or network of computers networks, includes computers connected through a set of communication protocols known as transmission control protocol/Internet protocol (TCP/IP). One popular component of the Internet is the world wide web (www) or “the web,” which is a collection of resources on servers on the Internet that utilize a hypertext transfer protocol (HTTP), which is an application protocol that provides users access to those resources, often referred to as “pages” which can be in static or dynamically generated format, including text, form entry fields, graphics, images, sound, video, etc. Using a standard generalized markup language (SGML), such as the hypertext markup language (HTML), which is an information management standard for providing platform-independent and application-independent resources that retain formatting, indexing, and inter-resource hyperlinking information.

One reason for the Internet's rapid growth is the introduction and widespread use of web browsers, which are HTML-compliant user client software programs, or portions of other programs, providing simple graphical user interface (GUI) access to resources on web servers. The use of an HTML-compliant client, such as a web browser, involves specification of an address via a uniform resource locator (URL). A URL may include reference to a static resource or a reference to a software program on the web server, such as a common gateway interface (CGI) script, as an example, which may interact with a database, or other data source, to dynamically generate the resource requested by the user through the web browser.

When a user enters data into fields on a form web page and then submits that data, the browser communicates that data to the web server, as part of or accompanying the URL transmitted from the browser to the web server, which may then be use by the CGI script in interacting with the data source to generate the next resource for the user. Like many network protocols, HTTP uses a client-server model. An HTTP client such as a user browser, opens the connection and sends a request message to an HTTP server, such as a web server, which then returns a response message, usually containing the resource that was requested. After delivering the response, the web server closes the connection, which makes HTTP a stateless protocol, i.e. not maintaining any connection information between transactions. In other words, HTTP does not practically provide for maintaining a “session” as a user requests and interacts with various resources.

Since HTTP is a stateless protocol, designers needed to develop a method for conveniently maintaining a session between user interactions with different resources. One method of addressing this problem has become known as “setting a cookie” on a user's computer, which often involves the web server indirectly reading and writing certain information to “cookie” files on a user's hard drive via the browser. However, security constraints dictate that if a given server sets a cookie on a browser, the browser may not send that cookie to a server in a different Internet domain from the one in which the cookie originated. Internet applications that reside in different Internet domains may not use a cookie as a shared session identifier and thus, the use of cookies does not fully address the session maintenance problem.

Other methods of maintaining a session include appending a session identifier to all URLs displayed to the browser, or adding the session identifier as a hidden field in all forms. When the URLs or the forms are submitted back to the server, the server recognizes the session identifier, allowing the server both to associate the request with the session, and to add the session identifier to all URLs and forms in the response.

This approach, commonly known as “URL-rewriting,” has the disadvantage that all pages and forms must be dynamically generated: a single submission of a URL or form without the session identifier breaks the continuity of the session. Most pertinently, URL-rewriting is unsuitable for session maintenance across disparate applications, since it is difficult or infeasible to retrofit existing applications to use identical session-management schemes, or even to share the same session identifier.

Valuable or confidential information, such as credit card account numbers, may be sent from a client to the server in some applications as in the case of purchasing items from a web site. To protect this confidential information, many servers implement a system for requiring the user or client to authenticate that user's or client's identification. In addition, many servers implement “firewalls” to protect the server from access by unauthorized users/clients. Such authorization code systems typically require a client/user to input the client/user's authorization every time a new server is accessed, or even when different pages on the same server are accessed. Such a method is often an inefficient use of a very busy data source and can lead to higher cost and complexity for data sources supporting web resources. Such a method also causes an inconvenience for the user/client in having to remember different authorizations for various servers.

There is therefor a need for a system addressing these and other related and unrelated problems.

### SUMMARY OF THE INVENTION

In addition to other implementations, in an Internet implementation, a single sign-on protocol for use by web servers places minimal requirements on browsers, independent of the actual authentication mechanism used by any of the individual web servers accessed by the user. Authentication itself is decentralized in this protocol, however, there is a centralized server that provides the means for transparent sign-on and session management within a federation of servers. Users authenticate themselves with any one of a group of federated servers, each federated server communicates with the central sign-on server so that a user with a current session does not need to be reauthenticated by other servers in the federation. The protocol provides for encrypted communications between the federated web servers and the centralized server, allowing management of sessions, and increased security. Additionally, the protocol does not use persistent connections, providing a simpler method and system that will work effectively with existing security systems and will work effectively without the need to open additional holes in an already existing firewall.

### BRIEF DESCRIPTION OF THE SEVERAL VIEWS OF THE DRAWINGS

The accompanying drawings incorporated in and forming a part of the specification illustrate several aspects of the present invention, and together with the description, serve to explain the principles of the invention.

FIG. 1 is a block diagram illustrating various acceptable implementation of components associated with the present invention, and in accordance with various embodiments of the present invention.

FIGS. 2-5 are flow-chart representations of some steps performed in one implementation of one embodiment of the present invention.

Reference will now be made in detail to the description of the invention as illustrated in the drawings. While the invention will be described in connection with these drawings, there is no intent to limit it to the embodiments disclosed therein.

### DETAILED DESCRIPTION OF THE INVENTION

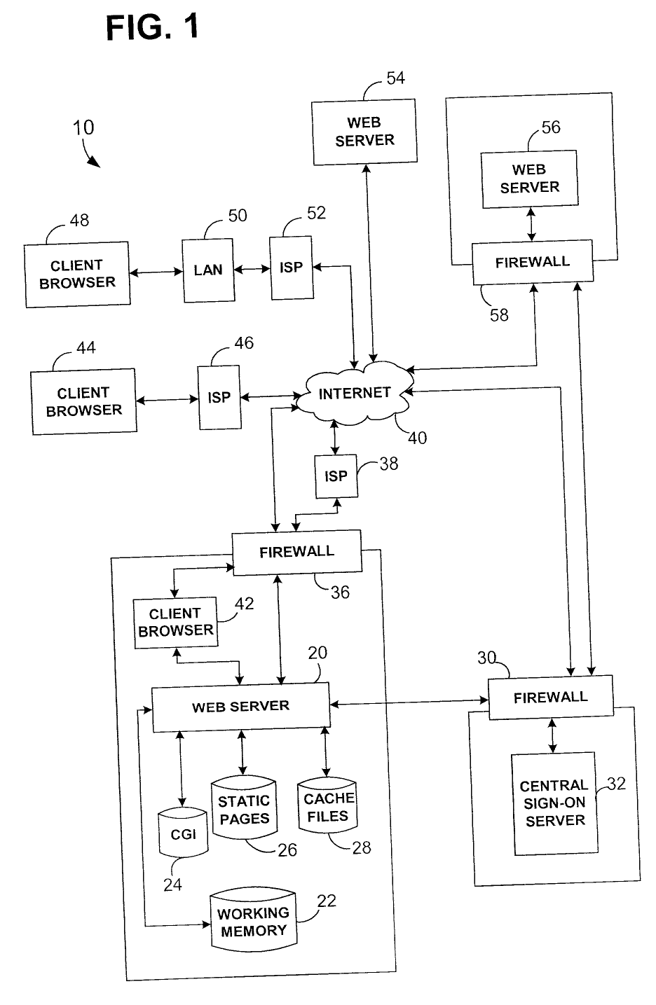

Turning now to the drawings, wherein like reference numerals designate corresponding parts throughout the drawings, FIG. 1 is a block diagram illustrating various implementations of components associated with a system and method for secure centralized session single sign-on and session maintenance, in accordance with various embodiments of the present invention. A web server 20 is shown connected to working memory 22, common gateway interface “CGI” programming 24, static pages 26, and cache files 28. A firewall 30 is shown connecting the web server 20 to a central sign-on server 32. Another firewall 36 is shown connecting the web server 20 to an Internet service provider (ISP) 38 which is connected to the Internet 40. A client browser 42 is shown connected directly to the web server 20. In such an implementation, the client browser 42 and web server 20 may both be protected/behind the same firewall 36. In such an implementation, the client browser 42 could communicate directly with the web server 20, and also through the firewall with the Internet 40 or other web servers 54, 56. A client browser 44 is shown connecting to the Internet 40 through an ISP 46. A client browser 48 is connected through a local area network (LAN) 50 and an ISP 52 to the Internet 40. Preferably except for the central sign-on server 32, though not necessarily each of the elements shown in FIG. 1 is representative of multiple similarly situated components. In addition, the elements shown in FIG. 1 may include conventional hardware and software components as would be understood by those reasonably skilled in the art of the present invention. For example, a client browser 42, 44, 48 is understood to include various types of conventional browsing functionality, including, for example, a browser software program running on a personal computer, as well as browser functionality incorporated into an operating system or functioning with other hardware, such as a handheld device, a television, etc.

As stated above, FIG. 1 illustrates various acceptable implementations of the present invention. For example, one implementation includes a client browser 44 operating through an ISP 46, the Internet 40, another ISP 38, and a firewall 36 to interact with the web server 20 and accompanying elements 24, 26, 28, which in turn interacts with the central sign-on server 32 through a firewall 30. Other implementations include providing access to the web server 20 for a client browser 48 through a LAN 50, an ISP 52, and the Internet 40. Still other implementations omit the Internet 40 entirely, including only a client browser 42 (and other similarly situated browsers as discussed above), the web server 20 with accompanying elements 24, 26, 28 as well as a firewall 30 and the central sign-on server 32. Also, the lines between the web server 20 and other elements should be understood to include direct local connections, local area network connections and wide area network connections. Of course, one ISP 38, 46, 52 might be used by multiple elements shown in FIG. 1, and the web server 20 is located within an ISP 38, 46, 52 in some embodiments. Firewalls are also variable in other embodiments, including the omission of one or more firewalls, as well as the addition of firewalls, such as between the web server 20 and the central sign-on server 32. In addition, other embodiments include other ordinarily stateless servers besides those that qualify as “web” servers. These statements describing other embodiments and implementations of the present invention are not intended to be comprehensive.

In one example implementation, the CGI programming 24, static pages 26, and cache files 28 are normally stored in non-volatile memory, such as one or more local hard drives, until executed or utilized in working memory, which includes as an example, standard random access memory (RAM). The web server 20 and other servers also preferably include other conventional elements, such as a high performance microprocessor, networking capabilities, internal bus systems, power supply, an operating system, input/output devices such as a keyboard, a mouse, a screen, etc., as would be understood by those reasonably skilled in the art of the present invention to perform the functions claimed herein.

However, the elements of the present invention can be implemented in any combination of software and firmware. In one preferred embodiment, the method and system is implemented in software that is stored in a memory and that is executed by a suitable instruction execution system. Nonetheless, this method and system which includes ordered listing of executable instructions for implementing logical functions, can be embodied in any computer-readable medium for use by or in connection with an instruction execution system, apparatus, or device, such as a computer-based system, processor-containing system, or other system that can fetch instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples, a non-exhaustive list, of the computer readable medium would include the following: an electrical connection (electronic) having one or more wires, a portable computer diskette (magnetic), a random access memory (RAM) (magnetic), a read only memory (ROM) (magnetic), and erasable programmable read only memory (EPROM or Flash memory) (magnetic), an optical fiber (optical), and a portable compact disk read only memory (CD-ROM) (optical). Note that the computer readable medium could even be paper or other suitable medium upon which the program is printed, as a program can be electronically captured, via for instance optical scanning of the paper or other medium, then compiled, interpreted, or otherwise processed in a suitable manner if necessary, and then stored in a computer memory.

The web server 20 in the present invention is one of a “federation” of servers. In the preferred implementation, the federation of servers is a number of servers which “trust” one another. In such an implementation, signing onto one server in the federation of servers allows a client/user access to all servers in the federation of servers without the need for re-authentication when contacting another federation server. Such an implementation also allows a client/user terminating a session on one of the federation of servers to terminate sessions on all servers within the federation without the need for the client to visit each server individually.

Note that separate servers within the federation of servers may be physically co-located, and may even be different sections, portions, web pages, applications, etc. within the same server. Further, any given server within the federation may be a member of multiple, independent federations. Each federation has a unique identifier, called a “federation identification” and all servers within a federation know the federation identification.

In the preferred implementation, each federation of servers has one server that is designated as the central sign-on server 32. The central sign-on server 32 may be co-located with one or more of the federation servers, or it may be a stand-alone server providing only the central sign-on function. In this implementation, the central sign-on server 32 has a securely encrypted communication channel with client browsers 42, 44, 48 and with all servers in the federation, for example via HTTPS (HTTP over SSL)._The individual servers within the federation of servers may or may not be able to communicate with each other, however, each server in the federation has means to communicate with, and to authenticate the identity of clients/users.

In the preferred implementation, each server in the federation of servers has an identifier, or a “server identification” uniquely distinguishing that server from all other servers in the federation of servers. The central sign-on server 32 is able to recognize each server by its server identification. Further, in such an implementation each server in the federation has a public digital certificate known to the central sign-on server 32. The central sign-on server 32 correspondingly has a public digital certificate known to each server within the federation of servers.

Preferably, all of the servers within the federation of servers and the central sign-on server 32 maintain the application, code, script, etc. and associated connectional hardware that implements the method and system described herein. Further, the application, code, script, etc. is maintained on the individual servers within the federation at a location known to the central sign-on server 32. In one implementation, each server in the federation contains a URL called the Single Sign-on Support URL at which resides the application, code, script, etc. on the server. In this implementation, the central sign-on server knows the Single Sign-on Support URL of each server in the federation.

All of the servers within a federation of servers use a mechanism for session maintenance that does not require URL-rewriting, including but not limited to, cookies, browser certificates, etc. In the preferred embodiment each server in a federation uses cookies for session maintenance.

In the preferred implementation, all communications between client browsers 42, 44, 48 and web servers, 20, 54, 56 are conducted in HTTP. These communications are also preferably encrypted, such as at the socket layer, the IP layer, etc. Further, in this implementation, all communications between the federation servers and the central sign-on server 32 are similarly encrypted.

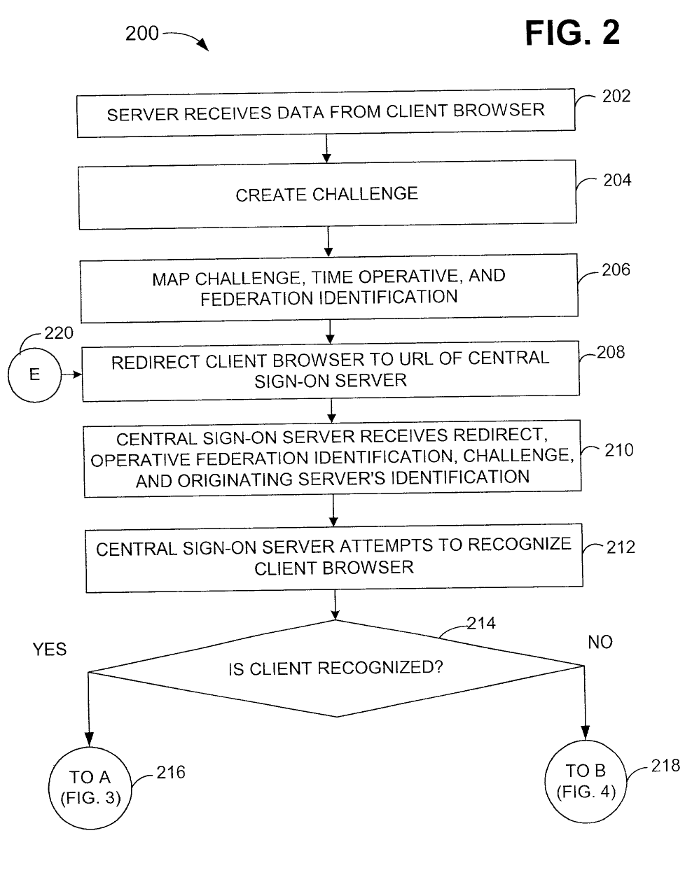

FIG. 2 is a flow-chart representation of selected basic steps 200 performed in one implementation of one embodiment of the present invention. With reference to FIG. 1 and FIG. 2, the steps 200 are from the perspective of the web server 20. While there are many acceptable implementations of the elements of FIG. 1, as discussed above, only one implementation will generally be discussed hereafter, merely for the purposes of clarity. Thus, based upon the above discussions, applicability of the following functions to other implementations would be understood by those reasonably skilled in the art of the present invention.

The selected basic steps 200 of FIG. 2 generally show initial session establishment. When data is received at the web server 20 from the client browser 42 (step 202), the web server 20 creates a unique, random string called a challenge (step 204). The actual string of the challenge preferably includes at least three parts: a unique alpha numeric prefix, a non-alpha numeric delimiter character, and a sequence of random bytes. The random bytes may be generated in any of a number of methods. The web server 20 also internally maps the challenge to a record of at least the actual URL requested by the client browser 42 (or other browsers 44, 48, etc.), the time at which the challenge was generated, and the operative federation identification of the web server 20 (step 206). The web server 20 is one server in a federation of servers, as discussed above. The web server 20 may be a member of multiple, independent federations as discussed above. When mapping the challenge in step 206, the web server 20 will map the operative federation identification for each federation of which the web server 20 is a member to separate records on the web server 20. The web server 20 then redirects the client browser 42 to the central sign-on server 32 (step 208). The central sign-on server 32 may be the sign-on server for more than one federation, or may be a stand-alone server, or may be co-located with the web server 20.

When the client browser 42 is redirected to the central sign-on server 32 (step 208), at least the following query string parameters are preferably received by the central sign-on server 32: the operative federation identification, the challenge, and the web server's public identification (step 210).

After receiving the information (step 210), the central sign-on server 32 attempts to recognize the client browser 42 (step 212). In one implementation, the central sign-on server's attempt to recognize the client browser 42 is via a cookie on the client browser 42. In this implementation, if no such cookie exists on the client browser 42, then the client browser 42 likely has not established a session on any of the servers of the federation (step 214).

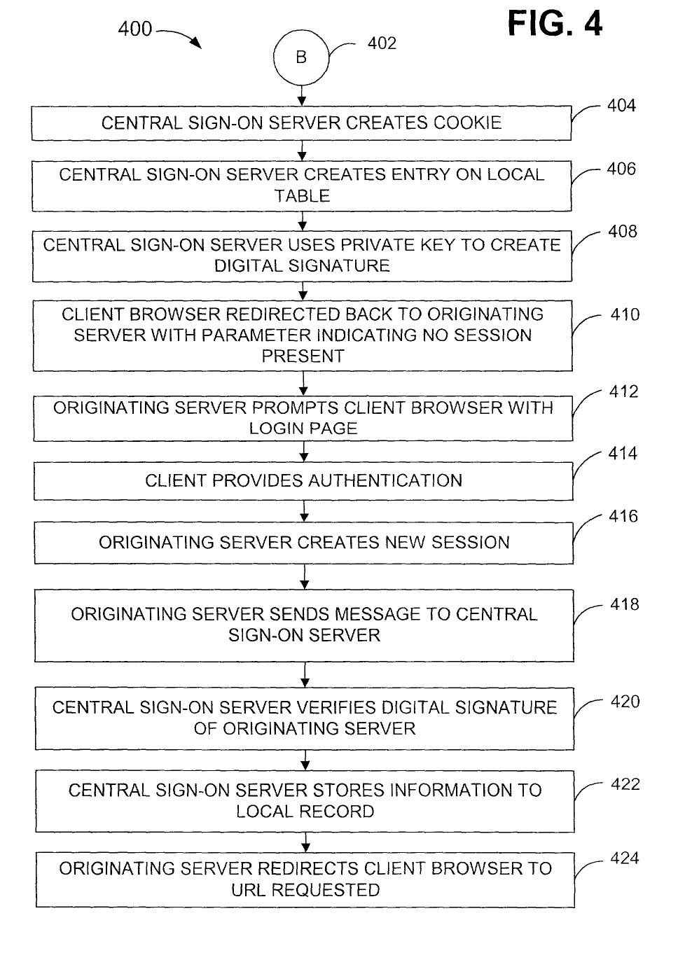

FIG. 4 is a flow-chart representation of selected basic generic steps 400 of one implementation of the present invention when the client browser 42 is not recognized in step 214 of FIG. 2. In this implementation using cookies, if the central sign-on server 32 does not recognize the client browser 42 via a cookie, the central sign-on server 32 creates a cookie with a new, unique value (step 404). Additionally, the central sign-on server 32 creates an entry on a local table located on the central sign-on 32 server using the newly created cookie and the web server 20 server identification as a concatenated primary key (step 406). Further, the central sign-on server 32 uses the central sign-on server's private key to create a digital signature. (step 408). The central sign-on server 32 then redirects the client browser 42 back to the web server 20 (step 410). The central sign-on server 32 further includes a repetition of the challenge (step 410). In the preferred implementation, the digital signature is created for use with all of the information sent to the web server 24 from the central sign-on server 32.

In the preferred implementation, the client browser 42 responds to the redirect by sending a request to the web server 20 as directed. Receiving the message, including the query string parameters indicating that there is no current session, the web server 20 prompts the client browser 42 with a log-in page (step 412). The client browser 42 provides authentication information in whatever way is appropriate such as by, for example, a log-in identification and password, unlocking a digital certificate with a pass key, etc. (step 414). The client browser 42 sends the authentication information to the web server 20, and the web server 20 creates a new session for the client (step 416). For as long as the client browser 42 keeps the session current, the web server 20 maintains an association of some sort between the session created for the client browser 42 and the challenge generated in step 204 of FIG. 2.

Having created a new session for the client user 42, the web server 20 sends a request to the central sign-on server 32 (step 418). In the preferred implementation the request is an encrypted HTTP request. The HTTP request to the central sign-on server 32 includes the challenge generated in step 204 of FIG. 2, a time-out value for the session (which in one implementation may be a set number of milliseconds, seconds, minutes or other time interval until the expiration of the session), and a parameter specifying that a new session has been created. The parameter specifying that a new session has been created on the web server 20 includes at least the log-in identification on the web server 20 of the client browser 42 for whom the new session has been created. Additionally, the HTTP request to the central sign-on server 32 will include a digital signature using the web browser's private key. In the preferred implementation, the digital signature will be for use with all information sent to the central sign-on server 32, including the challenge, the time-out value, and the parameter specifying that the new session has been created.

The central sign-on server 32 verifies the digital signal of the web server 20 (step 420). In one implementation, the central sign-on server 32 uses the web server's server identification to look up a digital certificate for the web server 20, which the central sign-on server 32 uses to verify the digital signature of the web server 20. If the digital signature is valid, then the central sign-on server 32 is assured that the web server 20 has created a new session for that client browser 42 and that, unless otherwise notified, the session should be considered valid until the time-out value sent to the central sign-on server 32 in step 418 of FIG. 4 expires. The central sign-on server 32 stores the information forwarded in step 418 of FIG. 4 locally on the central sign-on server 32. A valid session having been created on the web server 20, the web server 20 redirects the client browser 42 to the URL originally requested by the client browser 42 (step 424).

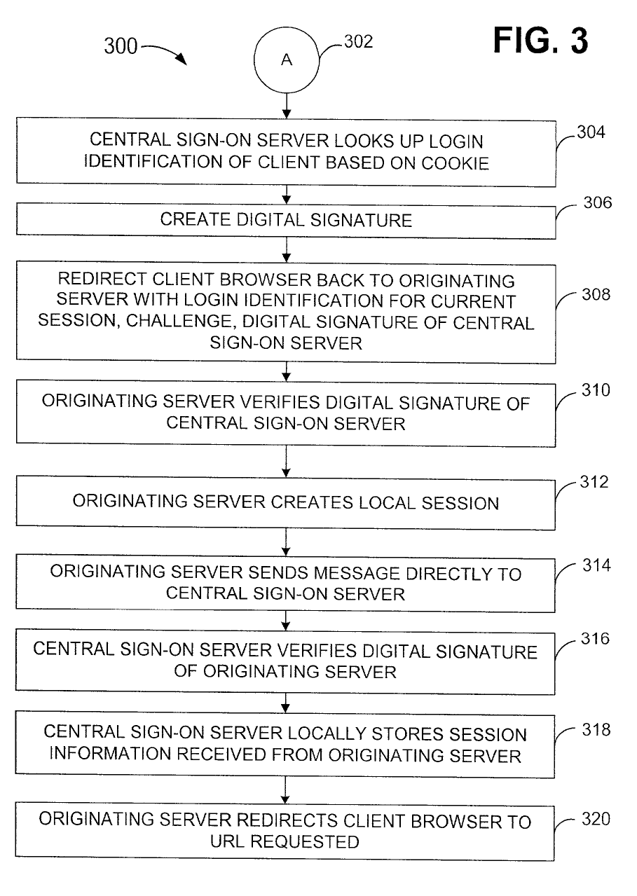

If the client browser 42 is recognized by the central sign-on server in step 214 of FIG. 2, the protocol of the present invention allows for transparent session establishment on the web server 20. FIG. 3 is a flow-chart representation of selected basic generic steps 300 of one embodiment of the transparent session establishment of the present invention. In one implementation wherein the central sign-on server 32 attempts to recognize a client browser 42 via a cookie in step 212 of FIG. 2, and the client browser 42 is recognized on the central sign-on server 32 (step 214 of FIG. 2), the central sign-on server 32 looks up the log-in identification of the client browser 42 based upon the cookie (step 304). In one implementation, all of the servers in the federation and servers have the same log-in identification for that client browser 42. In another implementation, the central sign-on server 32 is able to map that client browser's user name for the web server 20, and is able to map that client browser's user name for each server within the federation of servers.

The central sign-on server 32 then creates a digital signature on all information to be communicated by the central sign-on server 32 (step 306). In the preferred implementation, the central sign-on server 32 uses its private key to create the digital signature. The central sign-on server 32 then redirects the client browser 42 back to the web server 20 (step 308). The redirect includes parameters in the query string, including the log-in identification on the web server 20 associated with the client browser 42, the challenge, and the digital signature of the central sign-on server 32 on all of this information (step 308). The client browser 42 responds to the redirect by sending the request to the web browser 20.

The web browser 20 verifies the digital signature of the central sign-on server 32 (step 310). The web browser 20 receiving the information forwarded by the central sign-on server 32 indicating that a current session is noted for that client browser 42 on a different federation server, creates a local session on the web server 20 for the client browser 42 (step 312). Having verified the central sign-on server's signature, the web server 20 is assured that a current session is in place for that client browser 42 on one of the federation servers. The web server 20 may thus initiate a local session for the client browser 42 without the need for the client browser 42 to provide authentication.

Having created a local session for the client browser 42, the web server 20 sends a request directly to the central sign-on server 32 (step 314). In the preferred implementation, the request is an encrypted HTTP request. Included in the HTTP request to the central sign-on server 32 is at least the challenge generated in step 204 of FIG. 2, the web server's server identification, a time-out value (in the preferred implementation a number of milliseconds until the expiration of the local session on the web server 20), a parameter specifying that a local session has been created on the web server 20 (including the log-in identification on the web server 20 on the client browser 42), and a digital signature on all of this information (step 314). In the preferred implementation, the digital signature is created using the web server's private key.

Receiving the HTTP request from the web server 20, the central sign-on server 32 verifies the digital signature of the web server 20 (step 316). In one implementation, the central sign-on server 32 uses the web server's server identification to look up a digital certificate for the web server 20 which the central sign-on server 32 uses to verify the signature. If the digital signature for the web server 20 is valid, then the central sign-on server 32 is assured that the web server 20 has created a new session for that client browser 42 and that the session should be considered valid until the time-out expires. Further, the central sign-on server 32 stores locally on the central sign-on server 32 the information received in the message of step 314 (step 318). Having created a new local session, the web server 20 redirects the client browser 42 to the URL originally requested by the client browser 42 (step 320).

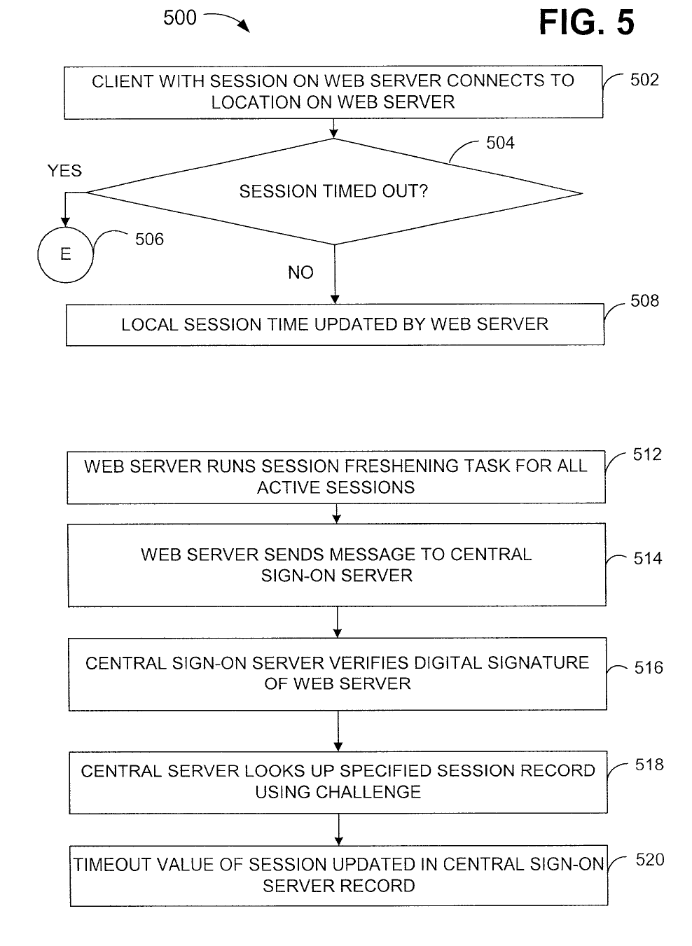

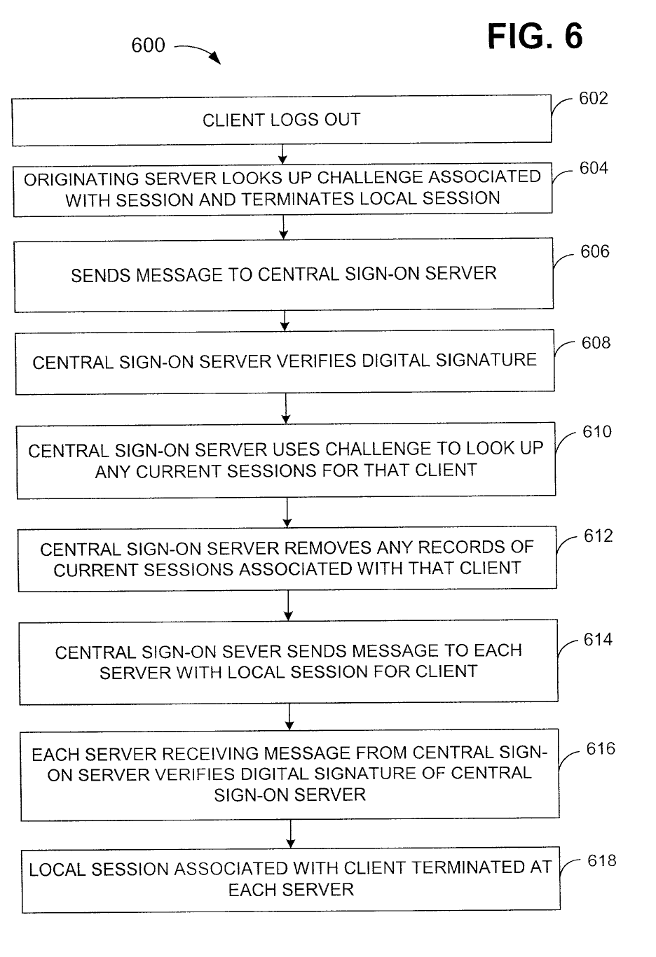

FIG. 5 is a flow-chart representation of selected basic generic steps 500 of one implementation of the secure session maintenance of the present invention. In the case of a client with a session on the web server 20 wherein the client browser 42 connects to a location on the web server 20 (step 502), the web server 20 checks to determine whether the session has expired (step 504). In a preferred implementation, if the delta between the current time and the last access time of the session is less than the session time-out set in step 206 of FIG. 2, then the session is considered current and has not timed-out. Accordingly, the local session on the web server 20 is updated by the web server 20 (step 508) and the client browser 42 is allowed to connect to the requested location on the web server 20. If the web server 20 determines that the session has been timed out, then the session is not considered current and the client browser 42 is treated as if it has just initiated contact with the web server 20 (step 506, FIG. 5; step 220, FIG. 2). At that point, the basic steps 200 of FIG. 2 are followed.

Additionally, the web server 20 occasionally runs a session freshening task for all active sessions (step 512). All sessions, including but not limited to newly created sessions under the initial log-on steps 300, or the transparent session establishment steps 400, are subject to the session freshening task of step 512 of FIG. (step 510). Each server in the federation runs such a freshening task in the background. In a preferred implementation this session freshening task looks through a list of sessions contained on the web server 20 for any sessions that are due to expire on the central sign-on server 32 before the next time the session freshening task runs. For each such session, if the delta between the current time and the last accessed time is less than the recorded session expiration duration, then the session is considered current and is assembled into a list of sessions that need to be freshened on the central sign-on server (see step 508, 512).

Each item in the list is associated with a new timeout value calculated as follows:

new timeout value is equal to the configured expiration duration minus the difference between the current time and the last access time of the session.

After assembling the list, the web server 20 sends a message to the central sign-on sever 32 (step 514). In the preferred implementation, the message is an encrypted HTTP request to the central sign-on server 32. Included within the message to the central sign-on server 32 is information for each session on the list which needs freshening, including at least the server identification of the web server 20, the challenge that was originally used in creating the session on the web server 20, the new time-out duration for the session as calculated above, and a digital signature of the web server 20 on all of this information (step 514). Upon receiving the message, the central sign-on server 32 verifies the digital signature of the web server 20 (step 516). The central sign-on server 32 then looks up the specified session records using the challenges (step 518). The central sign-on server 32 updates the expiration times for each specified session in the record on the central sign-on server 32 (step 520).

FIG. 6 is a flow-chart representation of selected basic generic steps for explicit session termination 600 of one implementation of the present invention. The steps 600 generally describe the way in which the present invention ensures that a client who logs out or terminates the session on one server in the federation, has sessions terminated on all of the servers in the federation. The client browser 42 terminates the session with the web server 20 or logs out of the web server 20 (step 602). The web server 20 looks up the challenge associated with that session from a record located on the web server 20, and terminates the local session on the web server 20 (step 604). The web server 20 sends a message to the central sign-on server 32 for each federation to which the web server 20 belongs (step 606). In the preferred implementation, the message is an encrypted HTTP message containing at least the challenge generated by the web server at the creation of the session for that client browser 42, the web browser's server identification, a parameter indicating that the session on the web browser 20 has been explicitly terminated, and the digital signature of the web server 20 on all of this information (step 606). The central sign-on server 32 verifies the digital signature of the web server 20 (step 608). The central sign-on server 32 preferably uses the challenge sent by the web browser 20 in step 606 to look up on the central sign-on server 32 the record of any current sessions associated with the client browser 42 (step 610). For each federation server with a current session for the client browser 42, the central sign-on server 32 removes the record on the central sign-on server 32 for that session (step 612). The central sign-on server 32 then sends a message to each federation server for which the client browser 42 had a local session (step 614). In one implementation, the message to each federation server is an HTTP message including the challenge generated by the federation server in the creation of the local session on that federation server, a parameter indicating that the session has been explicitly terminated, and the central sign-on server's private digital signature on all of this information. Each federation server receiving a message from the central sign-on server 32 verifies the digital signature of the central sign-on server 32 (step 616). After verifying the digital signature of the central sign-on server 32, each federation server receiving a message terminates the local session on the federation server associated with the challenge (step 618). In this fashion, the client/user is insured that his sessions have been terminated at each federation server that he may have visited for each federation, and that any confidential or sensitive information can not be accessed by accident due to a connection or session left open under that client's username.

In concluding the detailed description, it should be noted that it would be obvious to those skilled in the art that many variations and modifications can be made to the preferred embodiment(s) described above without substantially departing from the principals of the present invention. All such variations and modifications are intended to be included herein within the scope of the present invention, as set forth in the following claims. In addition, all examples and implementations discussed above are intended to be non-limiting since additional examples are contemplated within the scope of the present invention.

We claim:

1. A method for transparent sign-on in a client-server environment, the method comprising the steps of:
receiving an encrypted communication on an originating server from a client, the client using a browser;
creating a challenge at the originating server;
sending an encrypted communication to a central sign-on server from the originating server;
receiving an encrypted communication on the originating server from the central sign-on server, wherein the communication received on the originating server includes a response to the communication sent to the central sign-on server;
updating a client session on the originating server; and
sending another encrypted communication to the central sign-on server from the originating server.

2. The method of claim 1, wherein the step of creating a challenge further comprises the step of recording on the originating server a URL requested by the client browser, a time at which the challenge was generated, and a federation identification.

3. The method of claim 2, wherein the step of sending an encrypted communication to a central sign-on server further comprises the steps of redirecting the client browser to the central sign-on server and sending to the central sign-on server the federation identification, the challenge, and a server identification.

4. The method of claim 1, wherein the step of receiving an encrypted communication on the originating server from the central sign-on server further comprises the step of receiving a digital signature of the central sign-on server for all information communicated from the central sign-on server.

5. The method of claim 4, wherein the step of receiving an encrypted communication on the originating server from the central sign-on server further comprises the step of receiving a redirection of the client browser on the originating server.

6. The method of claim 5, wherein the step of receiving a redirection of the client browser further comprises the steps of receiving a parameter indicating that no session was present on the central sign-on server, the challenge, and the digital signature on all of the information communicated from the central sign-on server.

7. The method of claim 5, wherein the step of receiving a redirection of the client browser further comprises the steps of receiving a parameter indicating that a session was present on the central sign-on server, the challenge, and the digital signature on all of the information communicated from the central sign-on server.

8. The method of claim 1, wherein the step of creating a client session on the originating server further comprises receiving authenticating information from the client browser.

9. The method of claim 8, wherein the step of updating a client session on the originating server further comprises creating a client session on the originating server.

10. The method of claim 1, wherein the step of sending another encrypted communication to the central sign-on server from the originating server further comprises the step of creating a digital signature on all information sent to the central sign-on server.

11. The method of claim 10, wherein the step of sending another encrypted communication to the central sign-on server further comprises the step of sending the challenge, a session time-out value, a parameter specifying that a session has been created on the originating server, a log-in identification of the client for which the session has been created, and the digital signature.

12. A method for transparent sign-on in a client-server environment, the method comprising the steps of:
receiving an encrypted communication on a central sign-on server, wherein the communication is from a web server;
recognizing a client on the central sign-on server;
sending an encrypted communication to the web server from the central sign-on server; and
receiving another encrypted communication on the central sign-on server from the web server.

13. The method of claim 12, wherein the step of receiving an encrypted communication on the central sign-on server from the web server comprises the steps of receiving a redirection of the client browser on the central sign-on server and receiving a federation identification, a challenge, an identification of the web server, and a digital signature of the web server.

14. The method of claim 12, wherein the step of recognizing the client on the central sign-on server further comprises the steps of creating a cookie on the client browser and creating a record of the client on the central sign-on server.

15. The method of claim 14, wherein the step of creating a record of the client on the central sign-on server further comprises the step of using the cookie and the identification of the originating server as a concatenated primary key.

16. The method of claim 12, wherein the step of recognizing the client on the central sign-on server comprises the steps of accessing a cookie on the client browser and looking up the client on the central sign-in server based on the cookie.

17. The method of claim 16, wherein the step of looking up the client based on the cookie comprises looking up the challenge associated with the client session from a record on the central sign-on server.

18. The method of claim 12, wherein the step of sending an encrypted communication to the web server from the central sign-on server comprises the step of creating a digital signature for all information communicated to the web server.

19. The method of claim 18, wherein the step of sending an encrypted communication to the web server from the central sign-on server further comprises the steps of redirecting the client browser back to the web server and communicating the client log-in identification for the current client session, the challenge, and the digital signature.

20. The method of claim 18, wherein the step of sending an encrypted communication to the web server from the central sign-on server further comprises the steps of redirecting the client browser back to the web server and communicating a parameter indicating that no session was present on the central sign-on server, the challenge, and the digital signature.

21. The method of claim 12, wherein the step of receiving another encrypted communication on the central sign-on server further comprises the steps of receiving an identification of the web server, a challenge, a session time-out value, and a digital signature for all information sent to the central sign-on server.

22. The method of claim 21, wherein the step of receiving another encrypted communication on the central sign-on server further comprises receiving a parameter specifying that a session has been created on the web server and a log-in identification of the client for which the session has been created.

23. The method of claim 12, further comprising the step of updating a record of the client session on the central sign-on server.

24. The method of claim 23, wherein the step of updating a record of the client session on the central sign-on server comprises the step of verifying a digital signature of the web server.

25. The method of claim 24, wherein the step of updating a record of the client session on a central sign-on server further comprises the steps of creating a record on the central sign-on server of the client session and the session time-out value.

26. A method for session maintenance in a transparent sign-on client-server environment, the method comprising the steps of:
running a session freshening task for sessions on a web server;
sending an encrypted communication to a central sign-on server from the web server; and
recognizing a session on the central sign-on server.

27. The method of claim 26, wherein the step of running a session freshening task comprises the steps of looking up a list of active sessions on the web server and determining whether a session will expire on the central sign-on server before the next time the session freshening task runs.

28. The method of claim 27, wherein the step of sending an encrypted communication to the central sign-on server from the web server comprises the step of sending a server identification of the web server, the challenge used in creating the session, a new time-out value for the session, and a digital signature for all information sent in the message.

29. The method of claim 28, wherein the step of recognizing a session on the central sign-on server comprises the steps of verifying the digital signature and using the challenge to look up a record of the sessions on the central sign-on server.

30. The method of claim 26, further comprising the step of updating a client session record associated with the session on the central sign-on server.

31. The method of claim 30, wherein the step of updating a client session record comprises the step of updating a time-out value for the session on the central sign-on server.

32. A method for session maintenance in a transparent sign-on client server environment, the method comprising the steps of:
recognizing a client on a web server;
terminating a client session on the web server;
sending an encrypted message to a central sign-on server;
recognizing the client on the central sign-on server;
updating a record of a session associated with the client;
sending an encrypted communication to a second web server, the second web server having a current local session associated with the client; and
terminating a local session associated with the client at the second web server.

33. The method of claim 32, wherein the step of recognizing the client on the web server comprises the step of looking up a challenge associated with a client session.

34. The method of claim 33, wherein the step of recognizing the client on the web server comprises receiving a communication from the client.

35. The method of claim 33, wherein a digital signature is created for all information communicated to the central sign-on server.

36. The method of claim 35, wherein the step of recognizing the client on the central sign-on server comprises the steps of verifying the digital signature of the web server and using the challenge to look up a record of any current session associated with the client.

37. The method of claim 32, wherein the step of updating a record of a session associated with the client comprises deleting a record on the central sign-on server.

38. The method for claim 32, wherein the step of sending an encrypted message to a second web server further comprises sending the encrypted message to each web server for which the central sign-on server has a record of an active session associated with the client.

39. The method of claim 38, wherein the step of sending an encrypted message to a second web server further comprises the step of sending a parameter indicating that the client session is terminated and a digital signature of the central sign-on server.

40. The method of claim 39, wherein the step of terminating a local session associated with the client at the second web further comprises the step of verifying the digital signature of the central sign-on server.

41. A system for secure single sign-on in a client-server environment, the system comprising:
a server, the server configured to communicate with a client;
a central sign-on server, the central sign-on server configured to communicate with the client and the server; and
means for identifying the client on the central sign-on server.

42. The system of claim 41, wherein the means for identifying the client on the central sign-on server comprises a Single Sign-On Support URL located on the server.

43. The system of claim 42, wherein the Single Sign-On Support URL comprises means for creating a challenge when the client initiates communication with the server, means for redirecting the client browser to the central sign-on server, means for communicating the challenge to the central sign-on server, and means for receiving a communication from the central sign-on server.

44. The system of claim 41, wherein the server and the central sign-on server are co-located on the same server.

45. The system of claim 41, wherein the server is a member of a federation of servers, where each member of the federation of servers is configured with a server identification, and configured to use a similar policy with regard to session management as a second server in the federation of servers.

46. The system of claim 45, wherein the server in the federation of servers is configured to send encrypted messages to the central sign-on server and receive encrypted messages from the central sign-on server.

47. The system of claim 46, wherein the central sign-on server is a central sign-on server for more than one federation of servers, each federation of servers being configured with a unique federation identification.

48. The system of claim 47, wherein the central sign-on server is configured to create a digital signature that is recognized by the server in the federation of servers.
